(19) United States
(12) Patent Application Publication
(10) Pub. No.: US 2007/0196109 A1
(43) Pub. Date: Aug. 23, 2007

(54) Secure optical communication system

(76) Inventor: Salah A. Al-Chalabi, London (GB)

Correspondence Address: NIXON & VANDERHYE, PC, 901 NORTH GLEBE ROAD, 11TH FLOOR, ARLINGTON, VA, 22203, US

(21) Appl. No.: 11/357,997

(22) Filed: Feb. 22, 2006

(51) Int. Cl. H04B 10/00

(52) U.S. Cl. 398/140

(57) ABSTRACT

A secure optical interferometric communication system and network with multiple access capability where one or more transmitters have an interferometer with phase/Doppler shift difference modulation of spread spectrum type which is used for secure communication with one or more receivers on the optical network where the spread spectrum modulation is known to one or more receivers. The optical source can be of narrow optical spectrum or broad optical spectrum. In the case of the broad optical spectrum source, the path length difference of the transmitting interferometer can be also used to increase the security communication where the path length imbalance is known to one or more receiver, and number of users on the multiple access network. The interferometric communication system, especially with broad spectrum optical sources, can interwork with conventional wavelength division multiplexing (WDM) system and time division multiplexing (TDM) system. The interferometric system can partially tolerate jamming by WDM and TDM systems, and can be made difficult to detect by unintended listener/s.

This invention relates to a secure optical communication system over an optical network that can support multiple users.

Optical communication systems can transmit information over optical fibre, free space or through the atmosphere. Interferometric optical transmission system and multiple access networks have been described in the US and International patent applications US2004165884 and WO 02/103935 A1, in the name AL-CHALABI, Salah and the subject matter of WO 02/103935 A1 is hereby incorporated by reference.

For certain applications, security of communication is an important requirement. As already known in the prior art, communication systems can be made secure by using spread spectrum (SS) encoding techniques. Spread spectrum encoding is characterized by its wide frequency spectra. The encoded signals occupy a much greater bandwidth than that of the baseband information bandwidth and the spreading encoding is done by using a function other than the information being transmitted. Commercial spread spectrum radio systems transmit an encoded signal bandwidth as wide as 20 to 254 times the bandwidth of the information being sent and some highly secure systems have employed bandwidths 1000 times their information bandwidth.

The spreading signal can be pseudonoise (PN) generated signals which can include pseudo-random signals (PRS), pseudorandom binary sequence (PRBS) signals, pseudorandom generator (PRG) signals, frequency hopping (FH), time hopping (TH), or direct sequence (DS) type signals. The main advantages of spread spectrum systems and receivers are their security and their ability to reject unintentional and intentional interference. Relevant publications are:

Jack K. Holmes; “Coherent Spread Spectrum System”, John Wiley, 1982,

Don J. Torrieri; “Principles of Secure Communication Systems”, second edition, Artech House, 1992],

“Handbook of Applied Cryptography”; Alfred J. Menezes, Paul C. van Oorschot, Scott A. Vanstone; 1997, CRC Press Inc.

Spread spectrum modulation generally produces a low power spectral density signal, making the transmitted signal difficult to detect or recognise by unintended listeners and resistant to jamming by intentional or unintentional interferers. The spread spectrum techniques can also enable multiple users to communicate over the same communication channel (multiplexing or multiple access) by utilising orthogonal, or roughly orthogonal, signals in a common frequency band.

[It will be understood that orthogonality of signals has a mathematical meaning where the inner product between two functions is zero. For example a sine and a cosine are orthogonal over 2π. Orthogonality can be temporal or spatial and a relevant example of spatial orthogonality arises in polarisation.]

A treatment of noise in digital optical transmission systems is given in:

“Noise in digital optical communication systems”, Gunner Jacobsen, 1994, Artech House Inc.

Treatment of optical receiver noise with optical preamplifiers is given in:

Optical fiber communication systems”; Leonid Kasovsky, Sergio Benedetto, Alan Willner; 1996, Artech House Inc.

A known secure optical spread spectrum system is implemented by modulating the optical intensity with the output of a spread spectrum signal generator such as a pseudonoise generator. For example, interferometric security systems have been disclosed in US patents U.S. Pat. No. 5,191,614 [in the name Lecong PHUNG], and U.S. Pat. No. 5,274,488 and U.S. Pat. No. 5,694,114 [in the name Eric UDD] which describe the use of a short coherence length optical source with a Sagnac loop interferometer. Such an interferometer sends counterpropagating beams around a loop and a transmitter sited along the loop injects an information signal which can then be received elsewhere on the loop. In the systems disclosed, additional modulation is added to the counterpropagating beams at the midpoint of the loop. This additional modulation masks the information signal anywhere else on the loop except at the point of origin and recombination of the counterpropagating beams. At the point of origin of the counterpropagating beams, the additional modulation in each direction cancels out and thus a receiver placed at the point of origin can receive the information signal.

The short coherence length of the optical source of a few tens of microns makes it difficult to match the path length of the counterpropagating beams except at the point of origin. The system receiver is therefore located at the point of origin such that the additional modulation cancels out, allowing the information signal to be demodulated without additional electronics. A modified version of the Sagnac based system is disclosed in US patent U.S. Pat. No. 6,690,890 [in the name Michael M. MORRELL et al]. However, all these systems rely on the property of a Sagnac interferometer that the counterpropagating beams have inherent self matching path length, i.e. zero path length difference, at the point of origin and recombination of the counterpropagating beams. This makes the Sagnac based system only really suitable for sending information to a single endpoint, such as in an alarm system.

It is known to use interferometric modulation in optical transmission. For instance, it is known to provide optical signals over an optical fibre by using an unbalanced interferometer at the transmitting end, a matched unbalanced interferometer at the receiving end and a light source of relatively short coherence length. An optical signal containing information can then be transmitted between the two interferometers. Various aspects of interferometer-based communications are discussed in WO 02/103935 A1, referenced above, including:

“coherence function” and “coherence length” as used in relation to optical sources used in interferometric modulation

techniques for measuring coherence function and coherence length

A useful definition of coherence length of a source for use in embodiments of the present invention might can be based on the maximum discrepancy in path differences between a transmitting and a receiving interferometer for which interference fringes created by the transmitting interferometer using the source can still be detected at the receiving interferometer. It can be expressed according to:
(speed of light)×1/(spectral width of the power density of the source)

It is also known to apply an encryption key to an interferometric communication channel to disguise an information signal carried on the link. This is published in:

B. Wacogne and D. A. Jackson; “Enhanced Security in a Coherence Modulation System Using Optical Path Difference Corruption”; IEEE Photonics Technology letters, vol. 8 no. 7, July 1996.

It is said here that, as long as the encryption key has a bandwidth similar to that of the information signal, decoding can be done at a receiver in order to receive the information signal. A low frequency, periodic square wave encryption key is shown.

According to a first aspect of embodiments of the invention, there is provided an interferometric optical communication system, comprising at least one transmitter and at least one receiver connected by an optical channel,

the transmitter being provided with an interferometer having an information signal source, a modulator for modulating an output signal of the interferometer, and a spread spectrum signal generator, the modulator being connected to both the information signal source and the spread spectrum signal generator such that the output signal to the optical channel can carry both an information signal and a spread spectrum signal, and

the receiver being provided with an interferometer, a demodulator for demodulating an output signal received from the transmitter via the optical channel to obtain the information signal, and a de-spreading signal generator connected to the demodulator

for providing a de-spreading signal complementary to the spread spectrum signal, wherein the spread spectrum signal generated by the spread spectrum signal generator has a greater bandwidth than the bandwidth of the information signal.

Preferably, the ratio between these two bandwidths is relatively large, for example at least 10:1. For high security, the ratio might more preferably be 100:1. Thus, for example, if the information signal has a bandwidth of 10 KHz, the bandwidth of the spread spectrum signal will be at least 1 MHz.

Embodiments of the current invention provide a secure interferometric optical communication system using spread spectrum techniques and enabling multiple access by one or more users over an optical communication channel such as optical fibre, free space, the atmosphere etc. Thus the optical channel in embodiments of the invention may comprise a channel in a network to which there are connected more than one transmitter and/or more than one receiver. Any receiver can potentially receive an information signal from any transmitter for which its demodulator is equipped with a de-spreading signal generator complementary to the spreading signal generator of the transmitter and where the path imbalance of the receiver's interferometer is matched to that of the transmitter's interferometer.

The use of a spread spectrum signal of greater bandwidth than the bandwidth of the information signal can give improvements in immunity to eavesdropping and/or resilience to jamming by another transmitter. This is because the power level of the signal in the optical channel at any particular frequency can be reduced below the power level of noise in the channel in use, making it particularly hard to detect, while a jamming transmitter would have to use a broad bandwidth, or indeed spread spectrum, jamming signal itself to be effective,

Preferably, the modulator is adapted to produce phase modulation greater than the modulus of π, causing a large index of modulation in the output signal. The combination of a high bandwidth ratio and index of modulation allows an optical source of relatively broad linewidth to be used in the transmitter because the signal can still be detected at the receiver even where the path imbalance in the interferometer of the transmitter is less than the coherence length of the optical source. For example, a source having a linewidth in the range from 10 nm to 30 nm could be used. However, it is preferred that the path imbalance in the interferometer of the transmitter is greater than the coherence length of the optical source.

Thus in preferred embodiments of the invention, where the bandwidth of the spread spectrum signal generated by the spread spectrum signal generator is Bₛ and the transmission rate of information items of the information signal is 1/T, it is preferred that Bₛ T is greater than unity and that the modulator is adapted to produce phase modulation greater than±π.

“Information items” are referred to above. In general, an “information item” can be represented by a signal with multiple variable characteristics such as a “multilevel” signal. The information content in a signal of M variables is log₂(M). In the case of M=2, this represents one bit of information, as referred to in conventional communications. Thus in a binary system an “information item” is the same as a bit.

In more detail, a secure interferometric optical communication system according to an embodiment of this invention may comprise:

i) one or more optical sources with known coherence length, and

ii) one or more transmitters

where each transmitter is provided with an interferometer having a phase/Doppler shift modulator in one or both arms, which modulator(s) is driven in use by the output of a spectrum spreading signal generator with spreading bandwidth Bₛ, the system further comprising:

iii) an information source which produces one or more items of information of duration T seconds,

iv) an optical communication channel connecting one or more of said transmitters to one or more receivers, and

v) one or more receivers

wherein each receiver is provided with:

a) an interferometer with a path imbalance which differs from that of the interferometer of at least one transmitter to which the receiver is connected by less than the coherence length L_{c} of the optical source,

b) a phase/Doppler shift demodulator in one or both arms which is driven by the output of a de-spreading signal generator complementary to the spreading signal generator of said at least one transmitter to which the receiver is connected,

c) one or more photodetectors at the outputs of the interferometer to convert the optical signal to an electrical signal,

d) locking apparatus to lock the de-spreading signal generator to said at least one transmitter's spreading signal generator,

e) a signal processor to recover the information generated by the transmitter's information source, and

f) a receiver controller to control the receiver.

The system can be used to transmit data, voice, television and multimedia content as well as for telemetry. The system can support multiple users, i.e. multiplex, using interferometric time-delay difference, Doppler shift (frequency or phase) difference and intensity modulation techniques.

The security of the basic interferometric system and the number of users of the system is influenced by the receivers' knowledge of the values of the path imbalances assigned to the transmitters' interferometers and the properties of the chosen spectrum spreading/de-spreading signals. The security and/or number of system users can be increased by using a spreading signal generator that produces a set of orthogonal, or nearly orthogonal, signals with zero average.

As mentioned above, the system is improved when the spreading signal's bandwidth is greater than the symbol transmission rate 1/T, i.e. Bₛ/Bₑ (or BₛT) is greater than unity, and the range of phase/Doppler shift difference between the two optical signals of the two arms of the transmitter interferometer is equal to or greater than (−π, +π). The security of the interferometric system can be further improved by spreading the power of the transmitted signal over a bandwidth Bₛ, by choosing ratio of Bₛ/Bₑ, to yield a signal power which is less than the noise power at the output of a receiver with bandwidth Bₑ. This will also make the system more difficult to detect by an unintended listener. The interferometric receiver which has a de-spreading signal that matches the spreading signal of the transmitter will achieve highest Signal-to-Noise-Ratio (SNR) in a receiver bandwidth Bₑ.

The system can be made to interwork with optical Wavelength Division Multiplexing (WDM) systems by using an optical filter at the input to the interferometric receiver to extract these wavelengths from the optical spectrum.

The system has some immunity to interference by jammers of narrow optical spectrum if the spreading bandwidth Bₛ is chosen such that power spectral density due to the jamming signal is low in the detection bandwidth Bₑ.

The system can also interwork with optical Time Division Multiplexing (TDM) systems by a conventional optical intensity demodulator and using balanced interferometric optical detection to demodulate the interferometric modulated signal. This type of receiver will give the system some immunity against jamming by TDM systems.

The receiver can also have photocells, or thermophotovoltaic cells to convert part of the available optical energy to electrical energy to provide power to drive the system. The converted energy can be stored in a re-chargeable battery.

Interferometric apparatus suitable for use in embodiments of the invention is disclosed in International patent application WO 02/103935 in the name Al-Chalabi, S, the content of which is hereby incorporated by reference.

Various further inventive aspects of embodiments of the invention are as set out in the claims hereto.

It is to be understood that any feature described in relation to any one embodiment may be used alone, or in combination with other features described, and may also be used in combination with one or more features of any other of the embodiments, or any combination of any other of the embodiments.

A secure optical communication system according to an embodiment of the invention will now be described, by way of example only, with reference to the accompanying drawing in which:

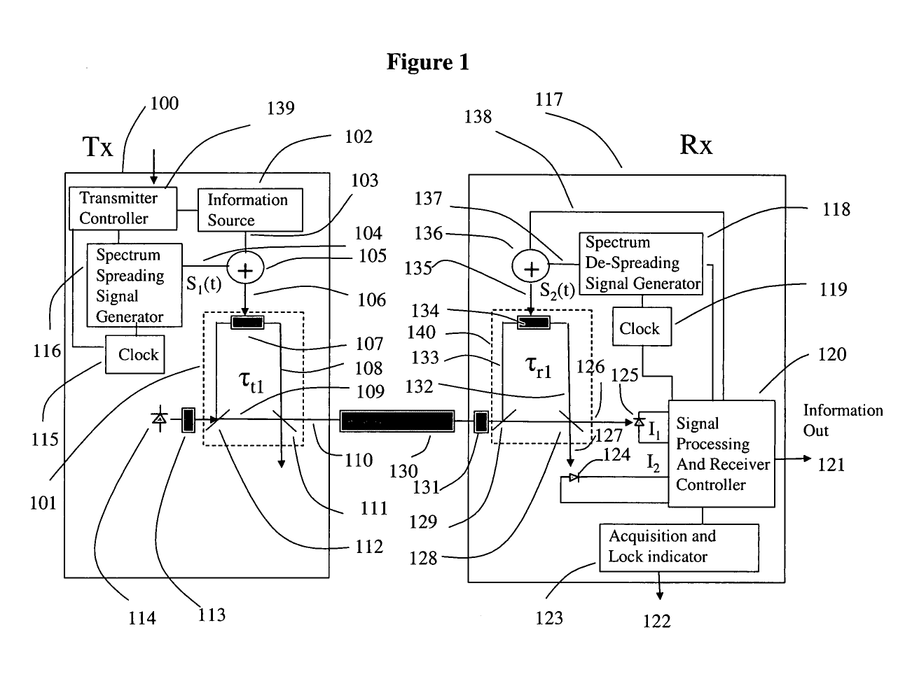

FIG. 1 shows a functional block diagram of a one-way version of the optical communication system;

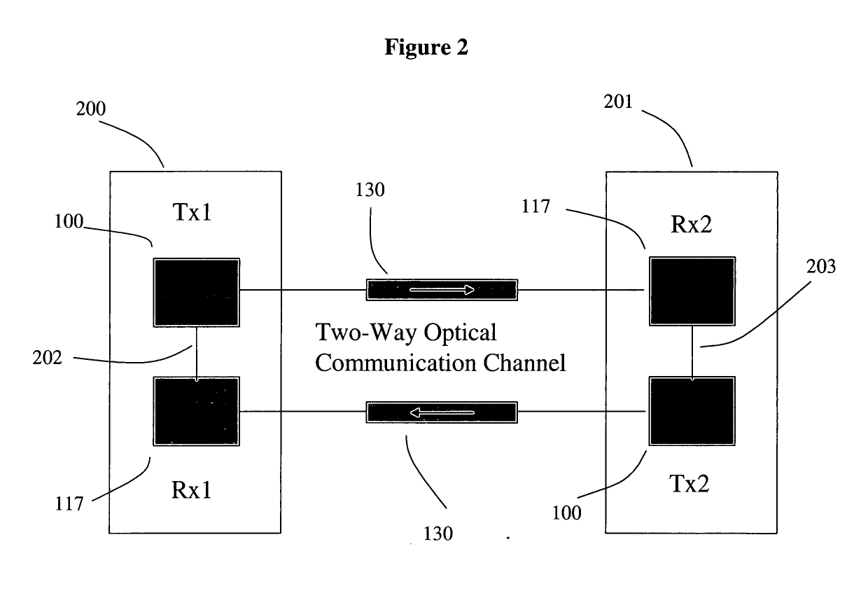

FIG. 2 shows a functional block diagram of a two-way version of the optical communication system;

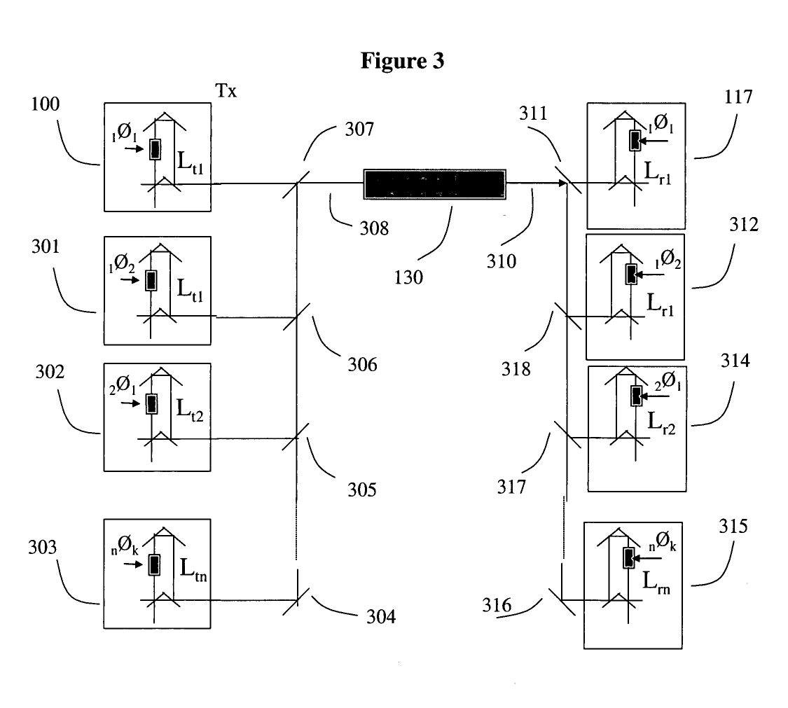

FIG. 3 shows a functional block diagram of a multiplexed version of the optical communication system;

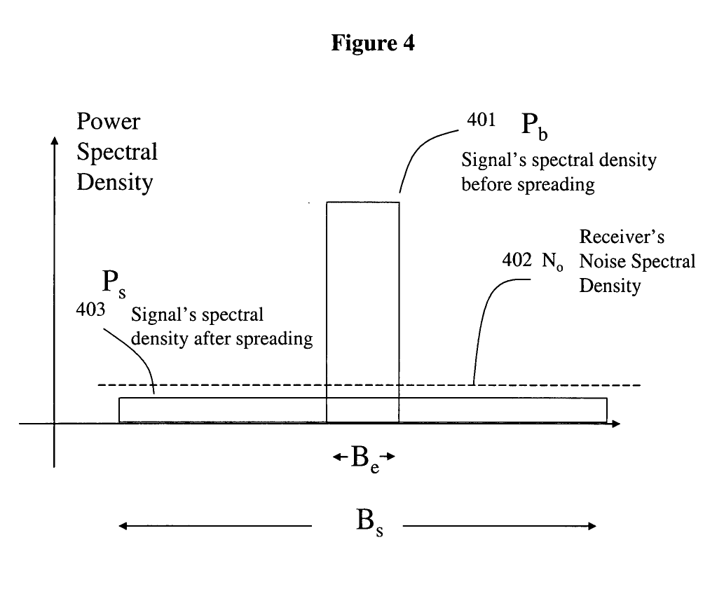

FIG. 4 shows a graph of power spectral densities at a receiver of the optical communication system;

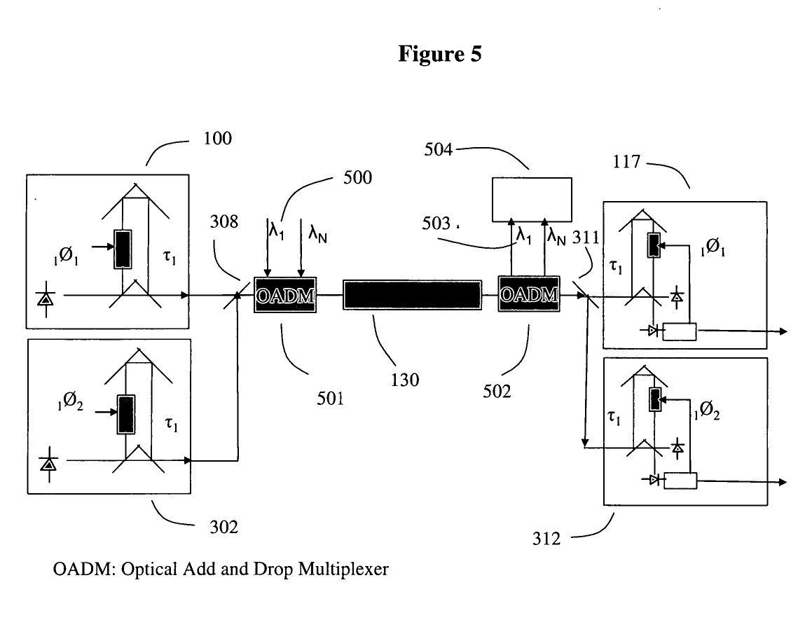

FIG. 5 shows a functional block diagram of an embodiment of the optical communication system using wavelength division multiplexing (WDM) signals; and

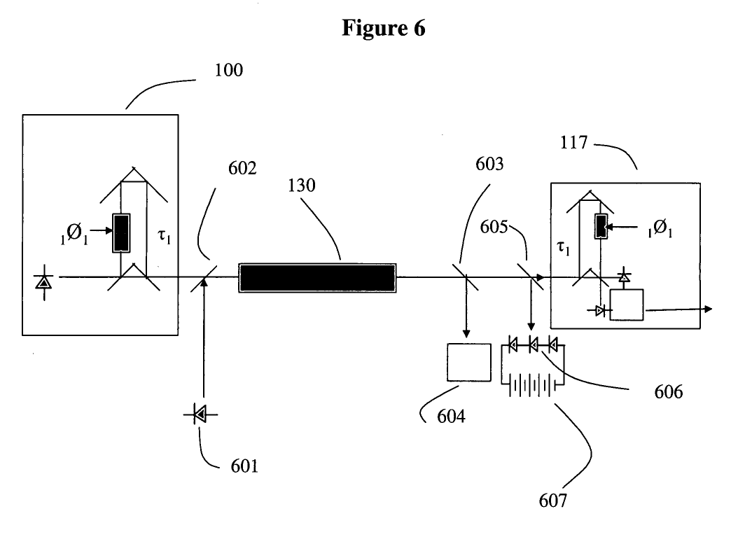

FIG. 6 shows a functional block diagram of an embodiment of the optical communication system using time division multiplexing (TDM) signals

Referring to FIG. 1, the transmitter 100 comprises an information signal source 102, a spread spectrum signal generator 116, an optical source 114 and an interferometer 101. The interferometer 101 is of a type, such as a Mach-Zehnder or similar, with at least two optical paths 108, 109 and beam splitters 111, 112. An important characteristic of the transmitter interferometer 101 is that one of its outputs can carry two signals, one being a reference and the second being the reference with either a time-delay or phase/Doppler shift modulation or both. The output of the information signal source 102 and the spread spectrum signal generator 116 are combined in an adder 105 and supplied to a phase/Doppler shift modulator 107 in one arm of the interferometer 101,

The interferometer 101 has a path length imbalance “Lₜ₁”, or a time delay difference τₜ₁=Lₜ₁/c where c is the speed of light, that is preferably greater than the coherence length (L_{c}) of the optical source 114. The optical source 114 can comprise an optical generator such as a laser diode (as shown) present in the transmitter or might alternatively comprise an optical delivery device such as an optical fibre, delivering optical radiation from a generator located elsewhere in a network to which the transmitter is connected.

The interferometer 101 can be fabricated using known techniques such as bulk optics or guided optics based on for instance lithium niobate (LiNbO₃) or silicon (including MEMS-Micro-Electromechanical systems) or Sol-gel based technologies.

An optical source 114 of short coherence length is preferably used. “Short” in this context can mean a few tens of micrometers to a few millimetres or even centimetres. A longer coherence length optical source 114 can be used, but a shorter coherence length is preferable as such sources can be made more secure. Examples of optical sources 114 that might be used include a superluminescent diode, an amplified spontaneous emission source or a multimode laser. A good example is an InGaAs or InGaAlAs superluminescent diode operating with central wavelength of 850 nm, 1300 nm or 1550 nm and a continuous spectrum of 40 nm. The coherence length of such a device is 18, 42 and 60 micro-meter for central wavelengths 850, 1300 and 1550 nm respectively.

A short coherence length in the source 114 can be more secure because the receiver and transmitter interferometers must have a difference in path length imbalance less than the coherence length of the source. If the coherence length is short, this creates an additional factor that an eavesdropper would have to know and accommodate. That is, the encryption now is not only the phase/Doppler modulation but also the path imbalance of the transmitter interferometer: effectively a code of two independent parameters. A shorter coherence length implies a wider optical spectrum and can imply lower optical power spectral density because the optical power is spread further in the optical spectrum domain although the total power is the same.

It is important the optical signals in the two arms of the interferometer 101 are each a replica of the optical signal of the optical source.

The spectrum spreading signal generator 116 provides an output signal S₁(t) 104 with spreading bandwidth Bₛ, driven by a clock 115 and controlled by a transmitter controller 139. The generator 116 can be a pseudorandom signal or sequence generator. The information source 102 produces one item of information in a period of T seconds (equivalent to a bandwidth Bₑ α 1/T) to drive the modulator 107 of the transmitter interferometer 101 resulting in a phase/Doppler shift difference between the optical signals carried by the two arms 108 and 109 of the transmitter interferometer 101.

The phase/Doppler shift modulator 107 can be an electromechanical, electro-optical or other known type of modulator which causes a change in the optical path length of the optical signal when an electrical signal is applied to the modulator. The modulator 107 can be integrated with other optical components of the interferometer 101 by using guided optics and semiconductor based technologies. The Doppler shift difference Ø(t) approximately equals, ignoring relativistic effects, the rate of change of the optical canier's phase θ(t) i.e.

$$ϕ ( t ) = \frac{ⅆ}{ⅆ t} θ ( t ) = \frac{\frac{ⅆ}{ⅆ t} {L}_{op} ( t )}{{λ}_{o}}$$

where Lₒₚ(t) is the optical path difference of the two arms of the interferometer and λₒ is the central wavelength of the optical source 114.

An optical element 113, such as a polariser or polarisation scrambler, might be necessary to match the optical source 114 to the transmitter interferometer's input.

The relationship between a change in the phase/Doppler shift produced between the arms of the interferometer 101 and the output of the transmitter's spreading signal generator 116, ignoring the signal from the information source 102, is

$${θ}_{1} ( t ) = {\int }_{0}^{1} {ϕ}_{1} ( {t}^{′} ) ⅆ {t}^{′} = \frac{2 π}{{λ}_{o}} [ {a}_{1} x {S}_{1} ( t ) + {b}_{1} ]$$

where a₁ and b₁ are constants.

The output 110 of the transmitter interferometer 101 is then transmitted over an optical channel 130 which can be for example an optical fibre, an optical fibre network, and/or free space, the atmosphere etc. The channel 130 might be provided by a network such as a Passive Optical Network (PON). An optical component of known type (not shown), such as a lens, might be needed to optimise the coupling of the optical signal to the optical channel 130. The output of the optical channel 130 is then fed to a receiver 117. It may be necessary to provide one or more known optical components 131 such as lenses or dispersion compensators to compensate for the optical channel dispersion.

The receiver 117 is of a complementary design to the transmitter 100. The output of the optical channel 130 is delivered to an interferometer 140 which has two optical paths 132 and 133, two beam splitters 129 and 129 and a phase/Doppler shift modulator 134. It may be necessary that the known optical components 131 provide a polarisation controller to match the polarisation of the optical channel 130 to that of the receiver's interferometer 140.

A characteristic of the receiver interferometer is that it should have two outputs that complement each other in power; i.e. the added power of the two outputs is proportional to the received power.

The receiving interferometer 140 has a path length imbalance L_{τ1} (or time delay difference τᵣ₁=L_{τ1}/c). The first step for establishing communication between the transmitter and receiver is to set the difference between the path imbalance of the transmitting interferometer Lₜ₁ and the path imbalance of the receiving interferometer L_{τ1} less than the coherence length L_{c} (i.e. |K_{τ1}−Lₜ₁|<L_{c}) of the optical source. The output of the de-spreading signal generator 118, which is driven by the clock 119 and controlled by the receiver's signal processor and controller 120, at the receiver has an output signal S₂(t), which can be added to the information demodulating signal 138, drives the phase/Doppler shift modulator 134 of the receiver interferometer resulting in a phase/Doppler shift difference between the two arms of the receiver interferometer.

The relationship between the difference in the phase θ₂(t) and the Doppler shift Ø₂(t) and the output of the receiver's spectrum de-spreading signal generator, ignoring the signal from the information demodulation signal, is

$${θ}_{2} ( t ) = {\int }_{0}^{t} {ϕ}_{2} ( {t}^{′} ) ⅆ {t}^{′} = \frac{2 π}{{λ}_{o}} [ {a}_{2} x {S}_{2} ( t ) + {b}_{2} ]$$

Where a₂ and b₂ are constants.

The optical signals at either one or both outputs 126 and 127 of the receiver's interferometer are converted to electrical current I₁ and I₂ by the photodetectors 125 and 124 respectively. The signal processor 120 at the receiver produces a signal proportional to the difference (I_{d}) between electric currents I₁ and I₂ and removes any d.c. component; i.e.
I_{d}α(I₁−I₂)

If the optical field of the optical source is a waveform that can by described by the function f(t) then the optical power at one of the outputs of the receiving interferometer, when the beams from the two arms of the interferometer spatially match, can be represented by
Pₒ+f(t)>f(t−[τ₁−τ₂])×Cos (θ₁[t]−θ₂[t])
where Pₒ is a constant representing the optical power at that output without the interferometric signal. The difference current I_{d} between the receiver's two photodetectors is proportional to
f(t)>f (t−[τₜ₁−τᵣ₁])×Cos (θ₁[t]−θ₂[t])αI_{d}(t)

The photodetectors in the receiver is normally followed by an integrator with an integration time T (this is equivalent to using an electrical low pass filter with bandwidth Bₑ α 1/T) equals the item rate (or “bit” rate in a binary signal system) of the information source at the transmitter. The integrator, or low pass filter, is part of the signal processor 120. The signal at the output of the integrator (or low pass filter) Qₒ(t) is proportional to

$${Q}_{o} ( t ) α {\int }_{t - T / 2}^{t + T / 2} f ( {t}^{′} ) xf ( {t}^{′} - [ {τ}_{t 1} - {τ}_{r 1} ] ) x Cos ( {θ}_{1} [ {t}^{′} ] - {θ}_{2} [ {t}^{′} ] ) ⅆ {t}^{′}$$

When the difference between the path imbalance of the transmitter interferometer and the path imbalance of the receiver interferometer is less than the coherence length of the optical source then we can assume that
τₜ₁−τᵣ₁=0
and if a₁=a₂=1 (which is satisfied if the phase/Doppler shift modulators at the transmitter and the receiver have the same signal to phase/Doppler shift coefficient), and b₁=b₂=0, then the output of the integrator (or the low pass electrical filter) is

$${Q}_{o} ( t ) α {\int }_{t - T / 2}^{t + T / 2} {f}^{2} ( {t}^{′} ) x Cos ( {S}_{1} [ {t}^{′} ] - {S}_{2} [ {t}^{′} ] ) ⅆ {t}^{′}$$

This is a maximum when the signals generated by the spectrum de-spreading signal generated by 118 at the receiver is synchronised with the spectrum spreading signal generator 116 at the transmitter, i.e.
S₂[t′]−S₁[t′]=0;

When this condition is satisfied then the signals S₁[t′] and S₂[t′] are synchronised at the receiver leading to
Cos (S₁[t′]−S₂[t′])=1 for all t′

When synchronisation is achieved, the receiver becomes ready to demodulate the information signal.

The process of bringing the receiver into synchronisation is called acquisition which can be divided into two sub-steps: the initial signal acquisition (coarse acquisition or coarse synchronisation) within an uncertainty of (±1/Bₛ); and signal tracking which performs and maintains fine synchronisation between the transmitter and the receiver. Strategies for achieving synchronisation in a conventional spread spectrum receiver are known and not discussed herein. The transmitter controller 139 ensures that the acquisition and synchronisation between the transmitter and receiver are achieved before communication starts. It also monitors the acquisition and synchronisation status during communication, and if they are lost then it will have to start the acquisition and synchronisation process again until they are achieved to restart transmission.

When synchronisation is achieved and maintained then detection and acquisition are achieved and this is indicated by the receiver's lock and acquisition indicator 122 and communication between the transmitter and one or more synchronised receivers can start in a one-communication multiple access network such as multicasting or broadcasting. The transmitted information can be voice, data, television multimedia, telemetry or other types of information. These operations together with demodulating the information 121 and 138 are controlled by the receiver's signal processing and receiver controller 120 and the transmitter controller 139.

The information can by imposed on the transmitted ineterferometeric signal using phase/Doppler shift difference or/and intensity modulation. The information can also be imposed on the spectrum spreading signal. Any changes in the transmitted signal can be demodulated by the receiver using the appropriate phase/Doppler shift tracking techniques, or/and amplitude/intensity demodulator, and/or demodulating the information contained in the spectrum spreading signal.

The main characteristic of the receiver interferometer is that it should have two outputs that complement each other in power; i.e. the added power of the two outputs is proportional to the received power.

The security and multiple access features of the interferometric communication are based on the possibility that the spectrum spreading signal S₁[t] and/or the value of the path imbalance of one or more of the transmitting interferometers are only known to certain receivers. The signal S₁[t] can be chosen such that the output of the receiver is as close as possible to zero if it can not achieve synchronisation by failing to match its spectrum de-spreading signal and the transmitter's spectrum spreading signal. However, the receiver's output is a maximum if it achieves synchronisation. To satisfy these requirements better, it is preferable that the phase/Doppler shift modulator causes a phase change uniformly distributed over the range (−π,+π or larger) and spectrum spreading bandwidth Bₛ is large enough to result in zero, or as close as possible to zero, cross-correlation between the spectrum spreading signals. The cross correlation between the spreading signals is zero where each spreading signal can uniquely identify one transmitter. Two spreading signals can be generated by using one spreading signal and the same signal delayed by more than the reciprocal of its bandwidth.

The advantages and disadvantages of the different spectrum spreading signals are covered in the prior art. There are several types of spectrum spreading signal generators that can produce orthogonal, or roughly orthogonal signals with zero average value. Examples of such signal generators are: direct sequence, frequency hopping, time hopping and pseudonoise generators. Direct sequence and pseudonoise generators have the best noise and anti-jamming performance and are the most difficult to detect (i.e. most secure), but they have a long acquisition time compared to other spreading signals. Frequency hopping has a relatively short acquisition time, but a complex spreading signal generator. The choice of the pseudonoise generator will be determined by required system performance such as acquisition time, ease of implementation, cost, simplicity, etc. If only a low level of security is required then the spectrum spreading signal can be a simple waveform, such as a single frequency or sawtooth waveform, known by the one or more receivers. However, if greater security is required then spectrum spreading signal of the pseudonoise type should be used.

In all cases, detection and synchronisation must be achieved before demodulation can be performed. Detection can be achieved with either one interferometer at the receiver, or two interferometers with the difference in their path lengths as close as possible to λₒ/4 (i.e. in quadrature) and with identical phase/Doppler shift modulation. In both cases, the output of the detector's receiver is monitored during the search period. In the case of one interferometer, the signal is detected when the receivers' output power increases. In the case of the two interferometers, detection is achieved when the output of the two interferometers change simultaneously.

Two-way communication between two users, each with a transmitter and receiver, will require the receiver of one user to transmit the detection, acquisition and lock information to the other user so that secure communication can be established. Referring to FIG. 2, in a two-communication system two users 200 and 201 each have a transmitter 100 and a receiver 117 that perform detection, acquisition (synchronisation and tracking) at both ends. Once this is achieved, then this is communicated from the receiver 117 to the transmitter 100 via 202 at 200 and via 203 at 201, and a two-way communication can start by imposing the information either on the difference in the phase, Doppler shift or/and amplitude of the optical signals in one or both arms of the transmitter interferometer. Any changes in the transmitted signal can be demodulated by the receiver by either phase/Doppler shift tracking techniques or/and an amplitude/intensity demodulator. The transmitted information can be voice, data, television multimedia, telemetry or other types of information.

Several users can communicate simultaneously and independently over the same optical channel forming a multiple access communication network. Referring to FIG. 3, transmitters 100, 301, 302 and 303 can be assigned any path length imbalance Lₜₙ and a unique phase/Doppler shift difference spreading waveform ₚØ_{q}(t) whose optical signals are combined using beam combiners 304, 305, 306 and 307 and the combined beam 308 is transmitted over the optical channel 130 whose output 310 is split by the beam splitters 311, 316, 317 and 318 to the receivers 117, 312, 314 and 315. Synchronisation between the spectrum de-spreading at any receiver and the spectrum spreading signal can only be achieved if
ₚØᵢ(t)−ₖØ_{q}(t)=0
which implies that
|Lₜₘ−Lᵣₘ|<L_{c}
i.e. only if the difference in the path imbalance of the receiving interferometer and the transmitting interferometer is less than the coherence length of the optical source, and the spectrum de-spreading signal at the receiver is synchronised with the spectrum spreading signal at the transmitter. Several transmitting interferometers can have the same path imbalance and they can be distinguished by the phase/Doppler shift spectrum spreading signal assigned to each transmitter.

An extra level of security can be introduced by modulating the optical intensity of the optical power of the transmitter interferometer. However, intensity modulation can be easier to detect by an unintended listener as conventional intensity demodulators are the easiest to construct and are most common among optical receivers. But it might be used for deception to lead the unintended listener to believe that the information is in the intensity modulation, although it is placed on the interferometric phase/Doppler shift modulation.

The interferometric optical communication can be made more difficult to detect by an unintended listener, and therefore more secure, if the ratio of spectrum spreading signal's bandwidth Bₛ to the electrical bandwidth of the receiver Bₑ (Bₛ/Bₑ or BₛT where T is the integration time of the receiver integrator which equals the period for transmitting information items) is large enough such that the signal-to-noise-ratio (SNR) at the output of the integrator of integration time T (or low pass filter of bandwidth Bₑ) is less than unity. Referring to FIG. 4, the receiver's noise Nₒ 402 is assumed to have a uniform power spectral density which represents typical types of noise encountered in optical communication. The noise can be thermal or shot noise or the addition of these types of noises or any other type of noise which is always present in a receiver. It also covers the noise when an optical pre-amplifier is used before the receiver's photodetectors. The power spectral density P_{b} 401 represents the interferometeric signal power spectral density, assume uniform, over its bandwidth Bₑ before spreading, and the power spectral density Pₛ 403 repreasenting the interferometric signal power spectral density after spreading over a bandwidth Bₛ.

If the required SNR before spectrum spreading and de-spreading is SNR_{b} then the transmitted interferometric signal can be made difficult to detect if the ratio of spectrum spreading signal's bandwidth Bₛ to the electrical bandwidth of the receiver Bₑ (Bₛ/Bₑ) is

$$\frac{{B}_{s}}{{B}_{e}} > \frac{1}{{SNR}_{b}}$$

This makes any receiver which has not achieved synchronisation to have an output which just looks like noise since the SNR is less than unity. However, the receiver which achieves synchronisation will achieve an SNR equal to SNR_{b} at its output which is larger than unity. For example, if T=100 μsec (Bₑ=10 kHz) and the required SNR_{b}=100, then the spreading bandwidth should be more 1 MHz to make it difficult to detect by a receiver which does not know the spreading signal even it knows the value of the path imbalance of the transmitting interferometer.

The interferometeric communication can interwork with, and have some immunity to interference or jamming by Wavelength Division Multiplexing (WDM) or Time Division Multiplexing (TDM) optical systems.

The invention can interwork with WDM systems. Referring to FIG. 5 discrete narrow optical spectrum wavelengths 500 can be added, by using Optical Add and Drop Multiplexer 501 (OADM), to the transmitted broad spectrum optical signal from the transmitters' interferometers. The combined optical signal can be transmitted over the same optical channel 130. At the output of the optical channel, or at the input of the receiver, an Optical Add and Drop Multiplexer 502 can be used to extract the discrete narrow spectrum wavelengths 503. The extracted WDM signal can then be demodulated in a standard manner using a bank of optical filters and intensity demodulators. The remaining optical signal, i.e. the optical signal at the input to the minus the WDM signal, can be fed to one or more receiver's interferometer 117 and 312 to demodulate the interferometeric modulation imposed by one or more transmitter's interferometer 100 and 302.

The invented interferometeric communication has some immunity to interference or jamming by narrow optical spectrum sources such as WDM. This is due to the spreading of the WDM signal by the receiver's de-spreading signal. The immunity is improved by choosing the spreading bandwidth (which should be identical to the de-spreading bandwidth) such that the power of the interfering WDM signals within the receiver bandwidth Bₑ is smaller than the power due to the interferometeric signal. Further immunity can be introduced by inserting an optical filter at the receiver input before the interferometer. The remaining broad optical spectrum signal is fed to the receiver's interferometer.

The system can also interwork with Time Division Multiplexing (TDM) systems with optical sources of either narrow optical spectrum or broad optical spectrum. In the case of a TDM system using a narrow spectral width source, such as a laser, an optical filter at the input of the receiver is required to extract it from the rest of the spectrum. The remaining broad spectrum optical signal is then fed to the receiver interferometer. Referring to FIG. 6 the intensity modulated optical source 601 used for TDM communication can be added using a beam splitter/combiner 602 to the broad optical spectrum signal of the transmitter interferometer 100, the receiver 117 of current invention is largely not affected by the presence such of intensity modulated signal if the receiver interferometer beam splitters/combiners 128 and 129 split the input optical signal equally; i.e. 1:1 split, where each of the two photodetectors 124 and 145 receive as close as possible one half of the input optical power. The TDM signal is then rejected by the balanced receiver which processes the difference current (I_{d}=I₁−I₂) from the two photodetectors. To extract the information of the TDM signal, the output of the optical channel can be split by the beam splitter 603 with part of the optical signal is used by a conventional optical receiver 604 to demodulate the TDM intensity modulated signal. Alternatively, the interferometeric balanced receiver with the two photodetectors 124 and 125 can be used to extract the TDM intensity modulated signal where the receiver signal processor produces a signal that represents the sum of the currents of the two photodetectors (i.e. I₁+I₂) which is proportional to the intensity of the optical signal at the input to the receiver.

In certain applications power might be supplied optically from a remote optical source. The transceiver can then include a beam splitter 605, photocells/thermophotovoltaic cells 606 and possibly a battery 607 to convert and store some of the optical energy to electrical energy which can be used to drive the system.

As discussed in WO 02/103935 A1 mentioned above, a preferred type of interferometer for use in embodiments of the invention are those with two outputs such as an off-set Michelson or a Mach-Zehnder, although a resonator type such as a Fabry-Perot could also possibly be used.

It will be understood that references to path length are references to optical path length. Therefore the path length control component could be anything capable of changing optical path length, such as a piece of electro-optic material which changes refractive index in response to changes in an electric field, or a piezo-electric material which changes the physical length of the path. However, a convenient arrangement is one in which the at least two interferometers share at least one reflector as the path length control component, the arrangement being such that movement of the shared reflector results in said path length change in relation to both interferometers. Such an arrangement is also described in WO 02/103935 A1.

1. An interferometric optical communication system, comprising at least one transmitter and at least one receiver connected by an optical channel,
the transmitter being provided with an interferometer having an information signal source, a modulator for modulating an output signal of the interferometer, and a pseudo-random signal generator, both the information signal source and the pseudo-random signal generator being connected to the modulator such that the output signal to the optical channel can carry an information signal together with a pseudo-random signal, and
the receiver being provided with an interferometer, a demodulator for demodulating an output signal received from the transmitter via the optical channel to obtain the information signal, and a signal generator connected to the demodulator for providing a signal complementary to the pseudo-random signal for use in said demodulation, wherein the pseudo-random signal generated by the pseudo-random signal generator has a greater bandwidth than the bandwidth of the information signal.

2. A system according to claim 1 wherein the pseudo-random signal comprises a spread spectrum signal.

3. A system according to claim 1 wherein the ratio between the bandwidth of the pseudo-random signal and the bandwidth of the information signal is at least 10:1.

4. A system according to claim 1 wherein the ratio between the bandwidth of the pseudo-random signal and the bandwidth of the information signal is at least 100:1.

5. A system according to claim 1 wherein the optical channel is a multiplex communication channel in a network to which there are connected more than one transmitter and/or more than one receiver.

6. A system according to claim 5 wherein an interferometer of each of at least two transmitters and an interferometer of each of at least two receivers has a path imbalance and is provided with means to adjust the path imbalance such that the path imbalances of transmitter/receiver pairs can be matched for transmission and reception of information signals therebetween.

7. A system according to claim 1 wherein the modulator is adapted to produce phase modulation having an index greater than the modulus of π.

8. A system according to claim 1 wherein the modulator is adapted to produce phase modulation such that the power level of the output signal to the optical channel is uniformly distributed across its bandwidth.

9. A system according to claim 1 wherein the modulator is adapted to produce phase modulation such that the power level of the output signal to the optical channel is less than the power level of noise at the same frequency in the optical channel in use of the system.

10. A system according to claim 1 wherein the information signal source has a coherence length of not more than 10 centimetres.

11. A system according to claim 1 wherein the information signal source has a coherence length of not more than 10 millimetres.

12. A system according to claim 1 wherein the information signal source has a coherence length of not more than 100 micrometers.

13. A transmitter for use in a system according to claim 1.

14. A receiver for use in a system according to claim 1.

15. An optical network for carrying communication signals to or from transmitting/receiving apparatus in optical form, the transmitting/receiving apparatus being adapted to employ interferometric modulation and demodulation as an information-carrying optical communication signal over the network, said interferometric modulation comprising a spectrum spreading signal.

16. An optical network according to claim 15 wherein the spectrum spreading signal is in a form specific to each respective transmitting/receiving apparatus adapted to employ interferometric modulation.

17. An optical network according to claim 15 wherein said interferometric modulation is applied by the use of an interferometer having a path imbalance and at least one receiving apparatus connected to the network is provided with an interferometer for receiving the modulation, said receiving interferometer having a path imbalance adjustor for adjusting its path imbalance to match that of the applying interferometer.

18. An optical network according to claim 17 wherein the communication signals are provided as modulation of optical radiation from an optical source and the path imbalance of the receiving interferometer is matched to within the coherence length of the optical source.

19. An optical network according to claim 15 wherein transmitting/receiving apparatus in use employing interferometric demodulation is provided with two interferometers whose path imbalances are in quadrature.

20. An optical network according to claim 15 wherein the information carried in the optical communication signal is in the form of phase/Doppler shift modulation.

21. An optical network according to claim 15 wherein the information carried in the optical communication signal is in the form of intensity modulation.

22. An optical network according to claim 15 wherein the spectrum spreading signal is used to transmit the information in the optical communication signal.

23. An optical network according to claim 15 wherein the network is adapted for use in broadcasting or multicasting the information-carrying optical communication signal.

24. An optical network according to claim 15 wherein the network is adapted for use in two-way communications.

25. An optical network according to claim 15 wherein the network is adapted for use in multiplexed communications.

26. An optical network according to claim 15 wherein the bandwidth of the spectrum spreading signal is chosen to reduce the power spectral density of the interferometric signal.

27. An optical network according to claim 25 wherein the network is adapted for use in wavelength division multiplexed communications by extracting narrow spectrum optical channels from the information-carrying optical communication signal.

28. An optical network according to claim 27, an optical filter being provided at the input of each transmitting/receiving apparatus to remove interfering wavelength division multiplex signals

29. An optical network according to claim 25 wherein the network is adapted for use in time division multiplexed communications.

30. An optical network according to claim 29 where the currents from two or more photodetectors at the outputs of a receiver interferometer or interferometers are used to extract the interferometric signal and attenuates the Time Division Multiplexing system by using a difference current from the appropriate photodetectors.

31. An optical network according to claim 29 where the currents from two or more photodetectors at the outputs of the receiver interferomer or interferometers are used to attenuate the interferometric signal and extract the Time Division Multiplexing signalling by using a sum of currents from the appropriate photodetectors.

32. An optical network according to claim 25 wherein the network is adapted for use in either or both of wavelength division multiplexed and time division multiplexed communications.

33. An optical network according to claim 15 wherein at least selected transmitting/receiving apparatus is provided with a power converter for converting at least part of received optical power to electrical power.
